(19) United States
(12) Patent Application Publication
(10) Pub. No.: US 2010/0025911 A1
(43) Pub. Date: Feb. 4, 2010

(54) BILL HANDLING DEVICE

(76) Inventor: Masao Sakamoto, Hyogo (JP)

Correspondence Address: BIRCH STEWART KOLASCH & BIRCH, PO BOX 747, FALLS CHURCH, VA, 22040-0747, US

(21) Appl. No.: 12/514,499

(22) PCT Filed: Nov. 13, 2006
(86) PCT No.: PCT/JP2006/322563

§ 371 Date: May 12, 2009

(51) Int. Cl. G07D 1/00; G07D 11/00

(52) U.S. Cl. 271/3.01; 271/9.01

(57) ABSTRACT

When different types of bills stored in storage cassettes (30a to 30h) are dispensed form an outlet (17), a priority order for dispensing the bills is set according to the characteristics of the bills. By both identifying the set priority order for dispensing the bills and referencing a table indicating storage destinations of the bills, the storage cassettes (30a to 30h) from which the bills are fed according to an order based on conditions specified are changed and thus the bills are dispensed.

### TECHNICAL FIELD

The present invention relates to a bill handling device that can either dispense or deposit and dispense a plurality of different types of bills.

### BACKGROUND ART

In recent years, various types of bill handling devices and coin handing devices have been introduced into windows of financial institutions and transportation facilities and cash desks of supermarkets, convenience stores and the like.

The above-mentioned bill handling devices include, for example, a bill handling device (see patent document 1) that is connected to a POS (point of sale) register or the like of a supermarket and that automatically dispenses change, an automated teller machine (see patent document 2) that is placed at a corner of a financial institution and that deposits and dispenses cash from and to a customer and a bill depositing and dispensing machine (see patent document 3) that is placed behind a counter of a financial institution and that deposits and dispenses cash from and to a teller. In addition to the devices disclosed in the patent documents, there are bill dispensing machines that only dispense bills.

Among these bill handling devices, the devices that deposit and dispense bills have a bill storage portion for feeding and storing bills. There are various types of storage methods using the bill storage portion. These include methods such as a stack method in which a stack of bills is fed and stored and a winding method in which bills are sandwiched between two tapes and wound around a rotary drum (see patent document 4).

In conventional bill handling devices, since, when bills are dispensed, it is generally customary to dispense bills to a customer such that a lower-value bill is placed in a higher position in a stack of bills, high-value bills are first fed and stacked, and low-value bills are then fed and stacked on top of the high-value bills. Thus, the bills are dispensed such that a lower-value bill is placed in a higher position. As described above, the conventional bill handling devices are set such that bills are fed in a given order, and that thus a user cannot change such a setting.

On the other hands, for example, there are some areas where it is customary to dispense bills such that a lower-value bill is placed in a higher position, and there are some areas where it is customary to dispense bills such that a higher-value bill is placed in a higher position. However, in the above-described bill handling device set such that bills are fed in a given order, bills are collected into a money dispensing mouth so as to be stacked in a predetermined order. Hence, in some areas where the bill handling devices are used, it is necessary to pick up bills stacked in the money dispensing mouth, change, before the bills are handed to a customer, the order in which the bills are stacked and hand them to the customer. This results in poor operability because bills need to be restacked.

To overcome this problem, the bill handling device of patent document 1 can eject and arrange bills dispensed as change in order of value, and can switch between a mode in which the bills dispensed as change are arranged in decreasing order of values and a mode in which they are arranged in increasing order of values. Specifically, this bill handling device has bill-dispensing-order switching means that can switch the order in which bills are dispensed, and thereby switches between a “higher-value bill higher position mode” in which a higher-value bill is placed in a higher position and a “lower-value bill higher position mode” in which a lower-value bill is placed in a higher position. Thus, the bill handling device can be set to suit a site where it is used.

Patent document 1: Japanese patent number 3495849
Patent document 2: JP-A-H09-161127
Patent document 3: JP-A-2004-145600
Patent document 4: JP-A-2006-260078

### DISCLOSURE OF THE INVENTION

### Problems to be Solved by the Invention

Disadvantageously, however, in the conventional bill handling device, as described above, the order in which types of bills (hereinafter, “denominations”) are stacked when they are dispensed is predetermined. Thus, it is possible that, since the size of bills may vary depending on the denomination, for example, depending on the order in which the denominations are stacked, bills of large-sized denominations are stacked on top of bills of small-sized denominations. When the bills are stacked as described above, the bills of the small-sized denominations are hidden by the bills of the large-sized denominations, with the result that an operator fails to identify the bills of the small-sized denominations and thus forgets to receive them.

Although the bill handling device of patent document 1 can switch between the two modes with respect to the order of values of bills, the predetermined modes are simply switched because these two modes are predetermined. Thus, since the relationship between the denomination and bill size varies depending on the country in which bills are used, when it is desired to set the mode according to the bill size irrespective of the denomination, it is not possible to flexibly cope with this situation. Hence, bill handling devices used in some sites where they are used have poor operability and flexibility.

### Means for Solving the Problem

An object of the present invention is to provide a bill handling device that can freely change the order in which bills are dispensed and that has excellent operability and flexibility.

To achieve the above object, according to the present invention, there is provided a bill handling device having a plurality of bill storage portions that can store bills by type and that can feed the bills one by one, a bill dispensing portion in which the dispensed bills fed from the bill storage portions are placed and a transporting portion that transports the bills fed from the bill storage portions to the bill dispensing portion. The bill handling device further includes: a memory that stores both storage destination information including information on types of the bills stored in the bill storage portions and priority order information on a priority order for the types of the bills fed from the bill storage portions; a setting/changing portion that sets or changes the priority order information stored in the memory; and a control portion that, when the bill is dispensed, feeds, based on the storage destination information and the priority order information stored in the memory, the bill from the bill storage portions and that dispenses the bill to the bill dispensing portion.

### ADVANTAGES OF THE INVENTION

According to the present invention, by specifying conditions for setting a priority order for bills, it is possible to set the priority order for denominations of bills that are dispensed from bill storage portions. With desired conditions, it is possible to automatically set the order of the denominations of bills that are stacked when they are dispensed. Simply by changing these conditions, it is possible to change the setting of the priority order for the denominations of bills that are fed from the bill storage portions. Thus, when the setting of the priority order for the denominations of bills that are fed from the bill storage portions is changed, simply changing the conditions allows the setting to be easily changed.

Moreover, when conditions on the size of bills are set, bills are dispensed, even if current or old bills or bills of a plurality of countries are handled, in the decreasing order of the size of the denominations, and thus bills stacked are dispensed in the decreasing order of the size of the denominations. Thus, it is possible to prevent a user from forgetting to receive bills when bills are received from an outlet, because bills of a smaller size are hidden by bills of a larger size.

### BRIEF DESCRIPTION OF DRAWINGS

FIG. 1 A perspective view showing the appearance and configuration of a bill depositing and dispensing machine according to an embodiment of the present invention;

FIG. 2 A schematic cross-sectional view showing the configuration of a mechanical block of the bill depositing and dispensing machine shown in FIG. 1;

FIG. 3 A block diagram showing the configuration of a control block of the bill depositing and dispensing machine shown in FIG. 1;

FIG. 4A A schematic diagram showing the flow of a process performed when the bill depositing and dispensing machine shown in FIG. 1 deposits bills;

FIG. 4B Another schematic diagram showing the flow of the process performed when the bill depositing and dispensing machine shown in FIG. 1 deposits bills;

FIG. 4C Another schematic diagram showing the flow of the process performed when the bill depositing and dispensing machine shown in FIG. 1 deposits bills;

FIG. 4D Another schematic diagram showing the flow of the process performed when the bill depositing and dispensing machine shown in FIG. 1 deposits bills;

FIG. 4E Another schematic diagram showing the flow of the process performed when the bill depositing and dispensing machine shown in FIG. 1 deposits bills;

FIG. 5 A block diagram showing the internal configuration of a storage destination determination portion and a dispensing order determination portion shown in FIG. 3;

FIG. 6A A schematic diagram showing the flow of a process performed when the bill depositing and dispensing machine shown in FIG. 1 dispenses bills;

FIG. 6B Another schematic diagram showing the flow of the process performed when the bill depositing and dispensing machine shown in FIG. 1 dispenses bills;

FIG. 6C Another schematic diagram showing the flow of the process performed when the bill depositing and dispensing machine shown in FIG. 1 dispenses bills;

FIG. 7 A schematic diagram showing the flow of a process performed when the bill depositing and dispensing machine shown in FIG. 1 collects bills;

FIG. 8 A flowchart showing an operation for setting a cassette denomination table;

FIG. 9 A flowchart showing an operation for setting the order in which bills are dispensed;

FIG. 10A A diagram showing an operation flow of a first operation example of the operation for setting the order in which bills are dispensed;

FIG. 10B Another diagram showing the operation flow of the first operation example of the operation for setting the order in which bills are dispensed;

FIG. 10C Another diagram showing the operation flow of the first operation example of the operation for setting the order in which bills are dispensed;

FIG. 11A A diagram showing the contents of a priority order table based on other conditions in the first operation example;

FIG. 11B A diagram showing the contents of a priority order table based on other conditions in the first operation example;

FIG. 12A A diagram showing the contents of a cassette denomination table showing a second operation example of the operation for setting the order in which bills are dispensed;

FIG. 12B A diagram showing the contents of a priority order table showing the second operation example of the operation for setting the order in which bills are dispensed;

FIG. 13A A diagram showing the contents of a priority order table based on other conditions in the second operation example; and

FIG. 13B A diagram showing the contents of a priority order table based on other conditions in the second operation example

### LIST OF REFERENCE SYMBOLS

11 Bill depositing and dispensing machine
12 and 13 Higher level terminal
14 Main body
15 Upper unit
16 Lower unit
17 Outlet
18 Inlet
19a and 19b Button for exclusive use
20 Display portion
21 Door member
22 Cashbox
23 Handle
24 Dial key
25 Unrecognized securities slot

### BEST MODE FOR CARRYING OUT THE INVENTION

An embodiment of the present invention will be described below with reference to the accompanying drawings. A bill handling device of this embodiment will be described below by way of example, using a bill depositing and dispensing machine. The bill depositing and dispensing machine of this embodiment is arranged at a counter of a financial institution such as a bank, more specifically, between tellers behind the counter.

### (The Configuration of the Bill Depositing and Dispensing Machine)

### 1. Mechanical Block

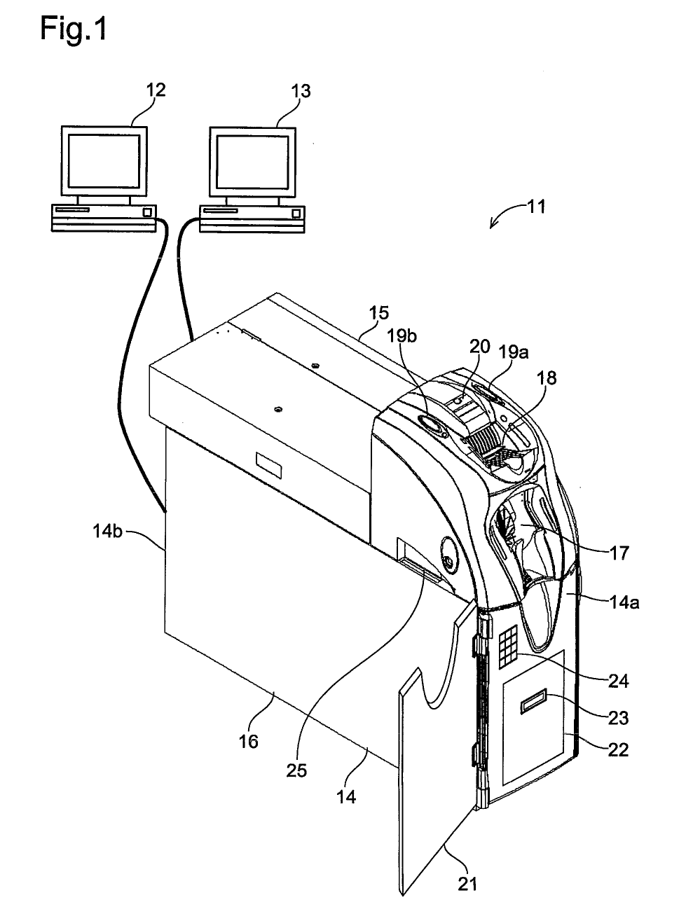

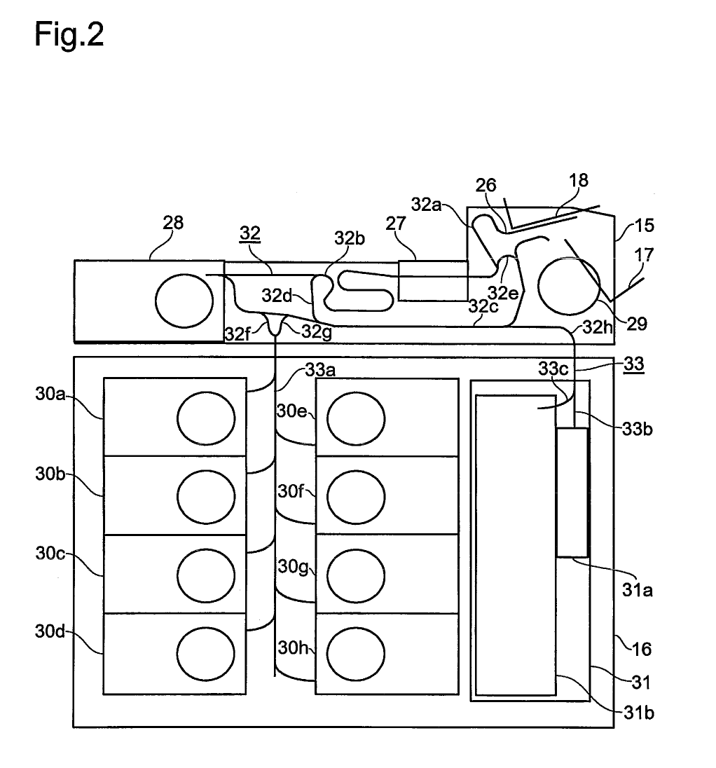

The mechanical configuration of the bill depositing and dispensing machine of this embodiment will first be described with reference to FIG. 1, which is a perspective view showing its appearance, and FIG. 2, which is a schematic cross-sectional view. As shown in FIG. 1, the bill depositing and dispensing machine 11 of this embodiment is connected to higher level terminals 12 and 13 operated by the tellers located on the left and right sides of the machine. The higher level terminals 12 and 13 can communicate with the bill depositing and dispensing machine 11. There are three ways of using the bill depositing and dispensing machine 11; only one of the higher level terminals 12 and 13 uses the bill receiving and dispensing machine 11; and both of them use the bill depositing and dispensing machine 11.

The main body 14 of the bill depositing and dispensing machine 11 is configured such that, when the operation surface operated by the tellers is assumed to be a front surface 14a and the opposite surface of the front surface 14a is assumed to be a rear surface 14b, the main body 14 is uprightly mounted with a narrow width in a lateral direction, a wide depth in a forward and backward direction and a long height in a vertical direction. The bill depositing and dispensing machine 11 has an upper unit 15 in the upper portion of the main body 14 and a lower unit 16 in the lower portion of the main body 14; the upper unit 15 and the lower unit 16 can be pulled out from the side of the front surface.

In this bill depositing and dispensing machine 11, the upper unit 15 is provided with: an outlet 17 which is disposed in its front surface and into which bills are dispensed; an inlet 18 which is disposed in the front side of its upper surface and through which bills are deposited; buttons 19a and 19b for exclusive use that are disposed in the left and right sides of an area where the inlet 18 is disposed; and a display portion 20 that is disposed in the rear side of the area where the inlet 18 is disposed and that is formed with an LCD (liquid crystal display) or the like. The buttons 19a and 19b for exclusive use are used for indicating which one of the tellers located on the left and right sides of the machine exclusively uses a bill depositing operation or a bill dispensing operation; they incorporate individual lamps. The lighting of the lamp indicates which one of the tellers has the exclusive use.

The lower unit 16 is provided with: an openable and closable door member 21 disposed in its front surface; a cashbox 22 that is disposed in an inside area which appears when the door member 21 is opened and that incorporates a cassette for storing bills; a handle 23 which is formed in the front surface of the cashbox 22 and with which the cashbox 22 is pulled out of the lower unit 16; a dial key 24 with which a password is entered to allow the cashbox 22 to be pulled out of the lower unit 16; and an unrecognized securities slot 25 which is disposed in a side surface of the lower unit 16 and at the boundary between the lower unit 16 and the upper unit 15 and into which unrecognized cash vouchers and checks other than bills are put.

As shown in the cross-sectional view of FIG. 2, the upper unit 15 is provided with: a feeding portion 26 that feeds bills placed in the inlet 18 into the main body on a one-by-one basis; a bill identification portion 27 that identifies a bill received from the feeding portion 26; a temporary storage portion 28 that temporarily stores a bill; and a dispensing portion 29 that temporarily stores bills to be dispensed. The lower unit 16 is provided with: eight winding-type (tape-type) storage cassettes 30a to 30h that store bills of specified denominations; and a collection cassette 31 having a counterfeit bill collection box 31a that collects counterfeit bills and a collection box 31b that collects bills other than counterfeit bills.

The temporary storage portion 28 of this embodiment is also of a winding type (tape type); this temporary storage portion 28 is disposed in the rear side of the upper unit 15. The bill identification portion 27 is disposed between the temporary storage portion 28 and the feeding portion 26; the dispensing portion 29 is disposed adjacent to the outlet 17. In the rear side of the lower unit 16, the storage cassettes 30a to 30d are disposed in this order from top to bottom; in front of the storage cassettes 30a to 30d, the storage cassettes 30e to 30h are disposed in this order from top to bottom. The collection cassette 31 is disposed in front of the storage cassettes 30e to 30h, that is, in the front side of the lower unit 16.

The upper unit 15 and the lower unit 16 are provided with a first transporting portion 32 and a second transporting portion 33, respectively, that transport bills between blocks.

Specifically, the first transporting portion 32 of the upper unit 15 is composed of: a transporting portion 32a that transports a bill from the feeding portion 26 through the bill identification portion 27; a transporting portion 32b that transports a bill from the bill identification portion 27 to the temporary storage portion 28; a transporting portion 32c that transports a bill from the temporary storage portion 28 to the dispensing portion 29; a transporting portion 32d that branches off from the transporting portion 32b into the transporting portion 32c; a transporting portion 32e that branches off from the transporting portion 32c into the transporting portion 32a; a transporting portion 32f that transports a bill from the temporary storage portion 28 to the storage cassettes 30a to 30h of the lower unit 16; a transporting portion 32g that transports a bill from the storage cassettes 30a to 30h to the transporting portion 32c; and a transporting portion 32h that branches off from the transporting portion 32c and that transports a bill to the collection cassette 31 of the lower unit 16.

The second transporting portion 33 of the lower unit 16 is composed of: a transporting portion 33a provided between the transporting portions 32f and 32g of the upper unit 15 and the storage cassettes 30a to 30h; a transporting portion 33b provided between the transporting portion 32h of the upper unit 15 and the counterfeit bill collection box 31a; and a transporting portion 33c that branches off from the transporting portion 33b and that transports a bill to the collection box 31b.

In the bill depositing and dispensing machine 11 configured as described above, the bill identification portion 27 determines the type and authenticity of a bill transported over the transporting portion 32a. Specifically, when the authenticity of a bill is checked, a determination is made as to which one of an authentic bill, a counterfeit bill and an unrecognized bill the bill corresponds to; when the type of a bill is checked, a determination is made as to the denomination of the bill, the direction in which the bill points and the country that issues the bill. Then, when bills are deposited, the temporary storage portion 28 temporarily stores receivable bills, other than unrecognized bills, that have been determined by the bill identification portion 27; when bills are dispensed, the temporary storage portion 28 temporarily stores bills that are transported to the dispensing portion 29 so as to be dispensed through the outlet 17. The dispensing portion 29 temporarily stores bills to transport them to the outlet 17; when bills are deposited, the dispensing portion 29 receives, from the transporting portion 32c, unacceptable bills and the like whose denominations cannot be determined by the bill identification portion 27, whereas, when bills are dispensed, the dispensing portion 29 receives, from the transporting portion 32c, bills that are dispensed through the outlet 17.

The storage cassettes 30a to 30h are set such that each cassette stores bills according to the denomination, the country and the like; when bills are deposited, bills received from the upper unit 15 are stored, and the bills are fed one by one to the upper unit 15. When bills are deposited, the counterfeit bill collection box 31a collects bills that have been determined to be counterfeit by the bill identification portion 27. Moreover, when bills are deposited, the collection box 31b stores, if bills are deposited beyond the capacity of the storage cassettes 30a to 30h (if an overflow occurs), the overflow bills, unrecognized bills and the like. When bills are dispensed, the collection box 31b collects rejected bills; when bills are collected, it collects bills stored in the storage cassettes 30a to 30h.

### 2. Control Block

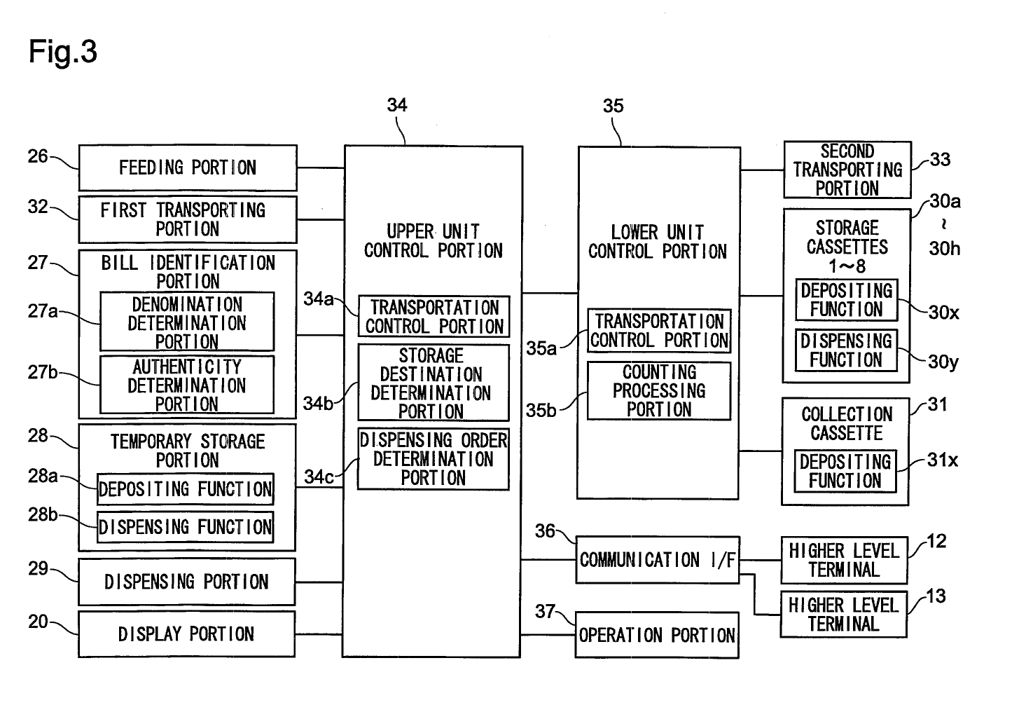

A description will now be given of the control block of the bill depositing and dispensing machine 11 incorporating the above-described mechanical block with reference to the block diagram of FIG. 3. As shown in FIG. 3, the bill depositing and dispensing machine 11 of this embodiment is provided with: an upper unit control portion 34 for controlling the operations of the blocks of the upper unit 15; a lower unit control portion 35 for controlling the operations of the blocks of the lower unit 16; a communication interface 36 through which to communicate with the higher level terminals 12 and 13; and an operation portion 37 for directly operating the bill depositing and dispensing machine 11.

The upper unit control portion 34 is provided with: a transportation control portion 34a for controlling, within the main body 14, transportation of bills by the transporting portions 32 and 33; a storage destination determination portion 34b for determining the storage destination of a bill; and a dispensing order determination portion 34c for determining, when bills are dispensed, the order in which they are dispensed. The upper unit control portion 34 controls operations of the display portion 20, the feeding portion 26, the bill identification portion 27, the temporary storage portion 28, the dispensing portion 29, the first transporting portion 32, the lower unit control portion 35, the communication interface 36 and the operation portion 37 including the buttons 19a and 19b for exclusive use. The upper unit control portion 34 also monitors a bill jam within the upper unit 15.

The lower unit control portion 35 is provided with: a transportation control portion 35a for controlling, within the lower unit 16, transportation of bills by the second transporting portion 33; and a counting processing portion 35b for counting the number of bills stored in each of the storage cassettes 30a to 30h and the collection cassette 31. The lower unit control portion 35 controls operations of the storage cassettes 30a to 30h, the collection cassette 31 and the second transporting portion 33. The lower unit control portion 35 is instructed by the lower unit control portion 34 to identify the storage destination of a bill and the order in which bills are dispensed from the storage cassettes 30a to 30h, and controls operation of the second transporting portion 33. The lower unit control portion 35 also monitors a bill jam within the lower unit 16.

The bill identification portion 27 is provided with: a denomination determination portion 27a for determining the denomination of a bill, the direction in which the bill points, the country and the like; and an authenticity determination portion 27b for determining the authenticity of a bill. The temporary storage portion 28 is provided with: a depositing function 28a for depositing bills from the first transporting portion 32 to temporarily store them; and a dispensing function 28b for feeding the bills temporarily stored to the first transporting portion 32. The storage cassettes 30a to 30h are likewise provided with: a depositing function 30x for depositing bills; and a dispensing function 30y for dispensing bills. The collection cassette 31 is provided with a depositing function 31x for depositing bills.

When the control block of the bill depositing and dispensing machine 11 is configured as described above, the upper unit control portion 34 receives, through the communication interface 36, a control signal from the higher level terminals 12 and 13 serving as high-level ones to the upper unit control portion 34 to control operations of the blocks. Moreover, the operation portion 37 is directly operated, and thus the upper unit control portion 34 receives a control signal corresponding to the operation of the operation portion 37 to control the operations of the blocks.

The transportation control portion 34a of the upper unit control portion 34 controls the feeding portion 26, the depositing function 28a and dispensing function 28b of the temporary storage portion 28, the dispensing portion 29 and the first transporting portion 32, with the result that bills are deposited, dispensed and collected. When bills are deposited, dispensed and collected as described above, the upper unit control portion 34 also feeds a control signal to the lower unit control portion 35, and thus the lower unit control portion 35 controls the depositing function 30x and dispensing function 30y of the storage cassettes 30a to 30h, the depositing function 31x of the collection cassette 31 and the second transporting portion 33.

### 3. Bill Depositing Process

In a case where bills are transported as described above, the storage destination determination portion 34b determines, if a bill is determined to be an authentic bill by the authenticity determination portion 27b of the bill identification portion 27 when bills are deposited, a storage destination from the storage cassettes 30a to 30h based on the denomination of the bill, the direction in which the bill points, the country of the bill and the like, which have been identified by the denomination determination portion 27a of the bill identification portion 27. In this case, if the capacity of one of the storage cassettes 30a to 30h, which is determined to be a storage destination, is found to reach an upper limit by reference to the count of the counting control portion 35b of the lower unit control portion 35, an overflow is determined to occur, and the bill is determined to be stored in the collection box 31b of the collection cassette 31. If a bill is determined to be a counterfeit bill by the authenticity determination portion 27b of the bill identification portion 27, the bill is determined to be stored in the counterfeit bill collection box 31a.

Then, when the result obtained by determination of the storage destination determination portion 34 on the storage destination of a bill is fed to the lower unit control portion 35, and if the bill is determined to be an authentic bill by the authenticity determination portion 27b of the bill identification portion 27, the depositing function 30x of one of the storage cassettes 30a to 30h, which is determined to be a storage destination, is activated, and the transporting portion 33a is operated to transport the bill to the storage destination. Here, if an overflow is determined to occur, and the bill is determined to be stored in the collection box 31b, the depositing function 31x of the collection box 31b is activated, and the transporting portions 33b and 33c are operated, with the result that the bill is stored in the collection box 31b. If the bill is determined to be a counterfeit bill by the authenticity determination portion 27b of the bill identification portion 27, the depositing function 31x of the counterfeit bill collection box 31a is activated, and the transporting portion 33b is operated, with the result that the bill is stored in the counterfeit bill collection box 31a.

When such bill depositing process is performed, a bill that is determined to be an authentic bill, a counterfeit bill or an unrecognized bill by the bill identification portion 27 is transported to the temporary storage portion 28, and is temporarily stored by activation of the depositing function 28a. Here, the storage destination determination portion 34b stores storage destinations determined according to the result by determination of the bill identification portion 27 on bills such that the storage destinations correspond to the order in which the bills are stored in the temporary storage portion 28. When all the determined bills are stored in the temporary storage portion 28, the denominations and authenticity of the determined bills and the number of bills of each denomination are displayed on the display portion 20. Unacceptable bills whose denominations cannot be identified by the bill identification portion 27 are transported to the dispensing portion 29, and are then returned through the outlet 17.

Then, when a storage request is made by the operation portion 37 or the higher level terminals 12 and 13, the bills stored in the temporary storage portion 28 are fed by activation of the dispensing function 28b, and are transported to the storage destinations and are stored therein.

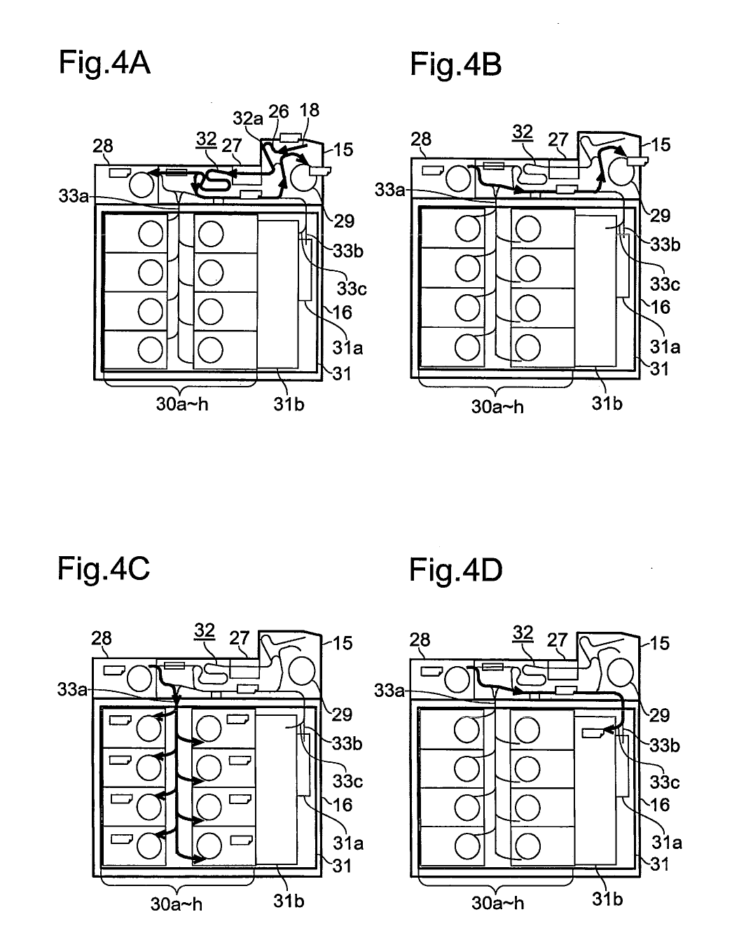

A brief description will be given of the flow of the process performed when bills are deposited, with reference to FIGS. 4A to 4E. When bills are placed on the inlet 18, as shown in FIG. 4A, the bills placed thereon are fed one-by-one by the feeding portion 26 to the transporting portion 32a and is transported to the bill identification portion 27. In the bill identification portion 27, the denomination of the transported bill, the direction in which the bill points, the country of the bill and the like are determined by the denomination determination portion 27a and the authenticity determination portion 27b, and the authenticity of the bill is determined.

Here, a denomination code and a country code that indicate the denomination of a bill and the country where the bill is used are fed to the upper unit control portion 34. When a determination is made by the denomination determination portion 27a, whether even bills of the same denomination and bills used in the same country are current or old is also determined, with the result that the denominations of the current and old bills are identified. When a determination is made by the denomination determination portion 27a and the authenticity determination portion 27b of the bill identification portion 27, the bill whose denomination cannot be determined is regarded as an unacceptable bill (in this embodiment, it is treated as a rejected bill). The bill that is determined to be counterfeit is regarded as a counterfeit bill, the bill whose authenticity cannot be identified is regarded as an unrecognized bill and the bill that is normal and real (genuine) is regarded as an authentic bill. Two bills (a plurality of bills that are stacked on top of each other and that are transported together) that are transported together to the bill identification portion 27 are also regarded as unacceptable bills.

The bill that is determined to be an authentic bill, a counterfeit bill or an unrecognized bill by the bill identification portion 27 as described above is transported through the transporting portion 32b to the temporary storage portion 28 and is temporarily stored in the temporary storage portion 28. The bill that is determined to be unacceptable is transported to the transporting portion 32b, then to transporting portion 32d and then to transporting portion 32c in this order, and is finally transported to the dispensing portion 29.

When all the bills placed on the inlet 18 are identified by the bill identification portion 27, and are distributed to the temporary storage portion 28 and the dispensing portion 29, the codes and determination results of the bills stored in the temporary storage portion 28 are identified by the upper unit control portion 34 in the order in which the bills are stored. Thus, the denomination, the country, the authenticity and the like of the bills that are stored in the temporary storage portion 28 are identified by the storage destination determination portion 34b, and their storage destinations in the lower unit 16 are determined.

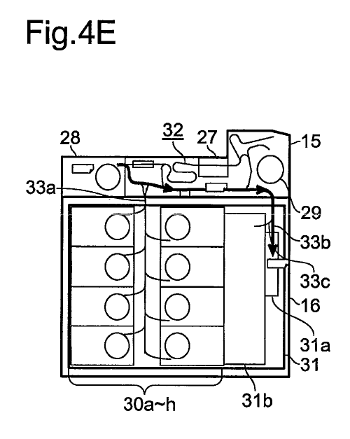

As shown in FIG. 5, the storage destination determination portion 34b is provided with: a cassette denomination table 34x in which the denomination codes and country codes of bills stored in the storage cassettes 30a to 30h are recorded; and a bill characteristic table 34y in which characteristics such as the length and width of bills specified by the denomination codes and country codes are recorded.

For convenience of description, in this embodiment, the bill characteristic table 34y in the form shown in FIG. 5 is assumed to be previously stored in the storage destination determination portion 34b, but if the characteristics of a bill such as its length and width are included in a template that is used for the bill identification portion 27 to perform an operation of identifying the bill, the upper unit control portion 34 or the like may use information included in the template to make the bill characteristic table 34y and store it. Here, since the template used by the bill identification portion 27 is changed according to the type of the bill used, the bill characteristic table 34y can be recreated according to the change of the template. Thus, it is possible not only to improve the efficiency with which the bill characteristic table 34y is created but also to prevent failure to make a setting.

Basically, the storage destination determination portion 34b assigns separate denomination codes to the current and old bills of the same country and denomination. However, only the denomination code for the current bill may be used for the current and old bills. When only one denomination code for the current and old bills is used as described above, the bills that are deposited and then stored in the temporary storage portion 28 are all regarded and handled as the current bill in the bill depositing and dispensing machine 11 irrespective of whether the bills are current or old.

When, as described above, the storage destination determination portion 34b selects, from the storage cassettes 30a to 30h, a storage destination of each bill that is determined to be an authentic bill by reference to the cassette denomination table 34x, the display portion 20 displays the number of bills of each denomination deposited, the number of bills that are determined to be a counterfeit bill in the authenticity check, the number of bills that are determined to be an unrecognized bill and the like. Here, the display portion 20 displays a display asking whether or not bills stored in the temporary storage portion 28 are stored in the cassettes of the lower unit 16.

When the operation portion 37 or the higher level terminals 12 and 13 are operated to prevent the storage, as shown in FIG. 4B, the bills stored in the temporary storage portion 28 are transported as a single unit to the transporting portion 32c, and the bills, as they are, are transported to the dispensing portion 29. Then, the dispensing portion 29 dispenses the bills transported from the temporary storage portion 28, to the outlet 17, along with bills that are determined to be unacceptable. That is, all the bills placed on the outlet 18 have been dispensed to the outlet 17.

In contrast, when the operation portion 37 or the higher level terminals 12 and 13 are operated to permit the storage, as shown in FIG. 4C, the bills stored in the temporary storage portion 28 are fed to the transporting portion 32c one by one. Here, the bill having one of the storage cassettes 30a to 30h as a storage destination is transported via the transporting portion 32f to the transporting portion 33a of the lower unit 16, and is finally stored in the storage destination among the storage cassettes 30a to 30h.

When the count of the counting processing portion 35b shows that a storage destination selected from the storage cassettes 30a to 30h has already reached an upper limit, as shown in FIG. 4D, the bill that is fed from the temporary storage portion 28 to the transporting portion 32c, is transported through the transporting portion 32h to the transporting portion 33c of the lower unit 16, and is finally stored in the collection box 31b. The bill that is determined to be a counterfeit bill is transported through the transporting portion 32c to the transporting portion 32 as shown in FIG. 4E, is then transported to the transporting portion 33b of the lower unit 16 and is finally stored in the counterfeit bill collection box 31a.

### 4. Bill Dispensing Process

As a result of an input being fed through the higher level terminals 12 and 13 or the operation portion 37, the amount of money dispensed is identified by the upper unit control portion 34. Then, when bills corresponding to the identified amount of money dispensed are dispensed, the dispensing order determination portion 34c identifies the necessary denominations and number of bills corresponding to the amount of money dispensed, and determines the order in which the bills are dispensed. Here, the storage cassettes 30a to 30h serving as the storage destinations for the denominations corresponding to the order in which the bills are dispensed are determined by the storage destination determination portion 34b.

In this way, the identified number of bills of the same denomination are only fed by activation of the dispensing function 30y of the storage destination of the denomination among the storage cassettes 30a to 30h. Here, after all the identified number of bills are transported from the specified storage cassette, bills are transported from the following storage cassette. Then, the transporting portions 33a and 32c are operated, and thus the bills corresponding to the denominations and number of bills identified by the dispensing portion 18 are transported and dispensed to the outlet 17 such that they are stacked in the desired order of the denominations.

When a bill dispensing process is performed as described above, bills may be transported to the temporary storage portion 28 and temporarily stored therein by activation of the depositing function 28a. Here, when bills are stored in the temporary storage portion 28, the depositing function 28a is activated, whereas, when bills are transported from the temporary storage portion 28, the dispensing function 28b is activated. Since bills are transported to the temporary storage portion 28 and temporarily stored therein, the order in which the bills are fed by the dispensing function 28b to the dispensing portion 29 is opposite to the order in which bills are transported from the storage cassettes 30a to 30h to the temporary storage portion 28.

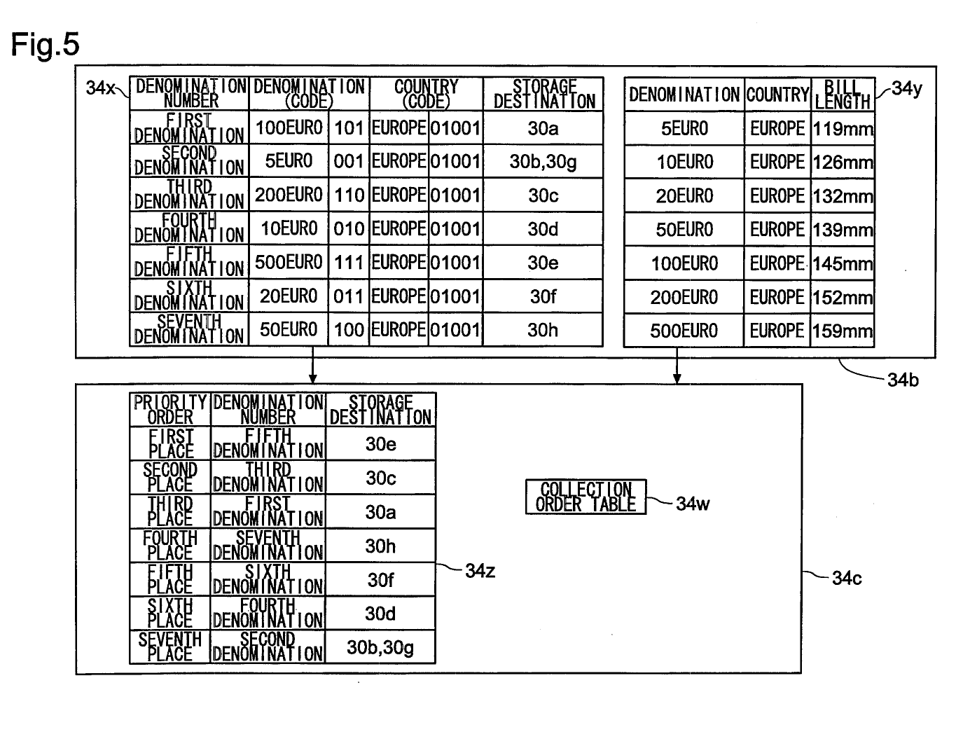

A brief description will be given of the flow of the process performed when bills are dispensed, with reference to FIGS. 6A to 6C. When the amount of money dispensed is input through the higher level terminals 12 and 13 or the operation portion 37, the amount of money dispensed is fed to the upper unit control portion 34. Then, the dispensing order determination portion 34c calculates the number of bills of each denomination based on the input amount of money, and thereafter identifies denomination codes and country codes corresponding to the necessary denominations. Based on the denomination codes and country codes, denomination numbers and storage destinations corresponding to the denominations are determined from the cassette denomination table 34x.

After the denomination numbers and storage destinations are determined, the order of the denominations of dispensed bills (corresponding to the above-described order in which bills are dispensed) is determined. Here, as a result of an input being fed through the higher level terminals 12 and 13 or the operation portion 37, the order of the denominations of dispensed bills may be set by the dispensing order determination portion 34c. Before a money dispensing request is made, the order of the denominations of dispensed bills may be input and set through the higher level terminals 12 and 13 or the operation portion 37 and may be previously stored in the dispensing order determination portion 34c. The dispensing order determination portion 34c, which determines, as described above, the order of the denominations of dispensed bills, is provided with a priority order table 34z shown in FIG. 5 that stores denomination numbers corresponding to the order of the denominations of dispensed bills. Operations for setting the priority order table 34z and for determining the storage destination will be described later.

Thereafter, bills are fed from specified storage cassettes 30a to 30h and are dispensed; there are two ways for achieving this: one way is to transport bills from the storage cassettes 30a to 30h directly to the dispensing portion 29, and the other way is to transport bills from the storage cassettes 30a to 30h and temporarily store them in the temporary storage portion 28 and then transport them to the dispensing portion 29. A description will first be given of the way in which bills are transported from the storage cassettes 30a to 30h directly to the dispensing portion 29. As shown in FIG. 6A, bills are fed from specified storage cassettes among the storage cassettes 30a to 30h to the transporting portion 33a.

Here, the storage cassettes 30a to 30h from which bills are fed are determined according to the identified order of denominations. The bills that are fed one by one are transported by the transporting portion 33a to the upper unit 15, and are transported through the transporting portion 32g to the transporting portion 32c. Then, the bills are transported by the transporting portion 32c to the dispensing portion 29 one by one. Since the bills are transported to the dispensing portion 29 according to the order of the denominations, the bills that are stacked according to the order of the denominations are placed in the outlet 17.

A description will now be given of the way in which bills are temporarily stored in the temporary storage portion 28 and are then transported to the dispensing portion 29. As shown in FIG. 6B, as when bills are transported directly to the dispensing portion 29, bills are fed to the transporting portion 33a from specified storage cassettes among the storage cassettes 30a to 30h, and are transported through the transporting portion 32g to the transporting portion 32c. Here, as when bills are transported directly to the dispensing portion 29, the order in which the storage cassettes 30a to 30h are specified are set equal to the order specified by the priority order table 34z. Since the bills that are transported to the transporting portion 32c are transported through the transporting portion 32e to the transporting portion 32b, the transported bills are identified by the bill identification portion 27 and are stored in the temporary storage portion 28. In the temporary storage portion 28, the bills are temporarily stored in the opposite order from the order of the denominations of dispensed bills.

When, as described above, the bills are stored in the temporary storage portion 28 in the order of the denominations of dispensed bills, the bills are transported by the transporting portion 32c to the dispensing portion 29 as shown in FIG. 6C. Here, all the bills that are stored in the temporary storage portion 28 are simultaneously fed to the transporting portion 32c, and are transported to the dispensing portion 29, and thus the bills that are stacked according to the order of the denominations are placed in the outlet 17 as the dispensed bills.

### 5. Collection Process

When, as a result of an input being fed through the higher level terminals 12 and 13 or the operation portion 37, the amount of money dispensed is identified by the upper unit control portion 34, and thus bills stored in the storage cassettes 30a to 30h are collected, as when the bill dispensing process is performed, the order in which bills are dispensed when bills are collected is identified by the dispensing order determination portion 34c. The storage destination determination portion 34b determines the storage cassettes 30a to 30h serving as storage destinations corresponding to the order of the denominations of dispensed bills. Here, as shown in FIG. 5, in addition to the priority order table 34z, the dispensing order determination portion 34c is provided with a collection order table 34w that stores the order in which bills are dispensed when bills are collected.

In this way, all the stored bills of the same denomination are fed by activation of the dispensing function 30y of the storage destination of the denomination among the storage cassettes 30a to 30h. Here, after all the bills are transported from the specified storage cassette, bills are transported from the preceding storage cassette. Then, the transporting portion 33a is operated, and thus the bills are transported to the upper unit 15, and are transported by the transporting portion 32c to the transporting portion 33c of the lower unit 16. In the lower unit 16, the depositing function 31x of the collection box 31b is activated, and the transporting portion 33c is operated, with the result that the bills are stored in the collection box 31b.

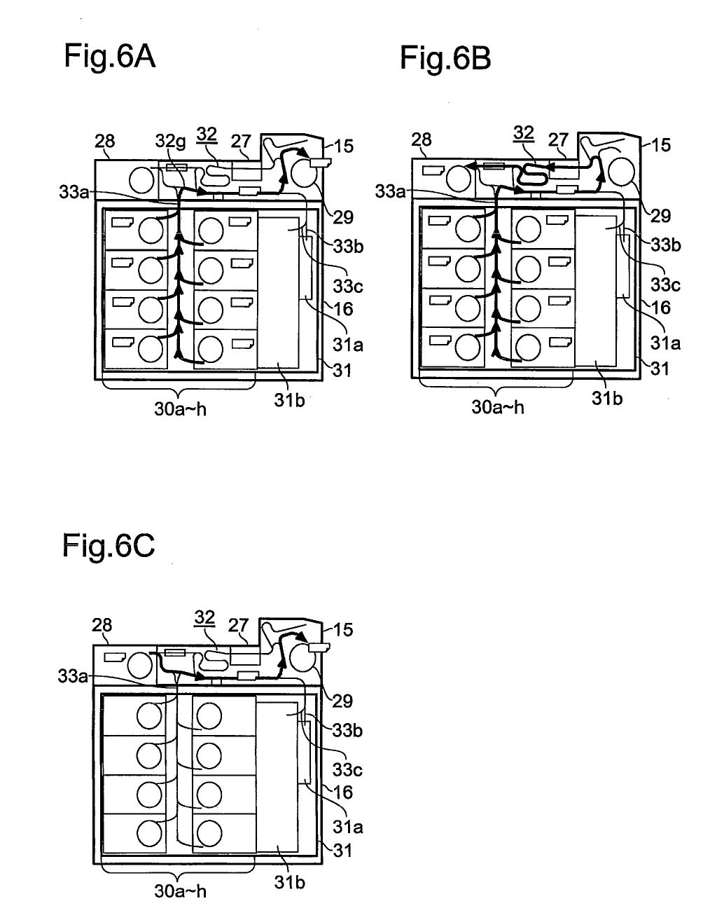

A brief description will be given of the flow of the process performed when bills are collected as described above, with reference to FIG. 7. As a result of a collection instruction being given through the higher level terminals 12 and 13 or the operation portion 37, the dispensing order determination portion 34c identifies, with the cassette denomination table 34x, storage destinations for denominations of bills, and identifies, with the collection order table 34w, the order of the denominations of collected bills (corresponding to the above-described order in which bills are dispensed). Like the bill dispensing process, the order of the denominations of collected bills may be set when a collection request is made or may be previously set and stored in the dispensing order determination portion 34c. The priority order table 34z may also serve as the collection order table 34w.

When the order of the denominations is identified, as shown in FIG. 7, bills are fed from specified storage cassettes among the storage cassettes 30a to 30h to the transporting portion 33a. Here, the storage cassettes 30a to 30h from which bills are fed are determined according to the identified order of the denominations. The bills that are fed one by one are transported by the transporting portion 33a to the upper unit 15, and are transported through the transporting portion 32g to the transporting portion 32c. Thereafter, the bills are transported by the transporting portion 32h to the transporting portion 33c of the lower unit 16, and are finally stored in the collection box 31b. Thus, in the collection box 31b, all the bills that are stocked according to the order of the denominations and that are stored in the storage cassettes 30a to 30h are stored.

(Operations for Setting the Order in which Bills are Dispensed and the Order in which Bills are Collected)

With reference to the accompanying drawings, a description will be given below of the operations for setting the order in which bills are dispensed and the order in which bills are collected, in the bill depositing and dispensing machine 11 that performs process operations as described above.

### 1. Cassette Denomination Table

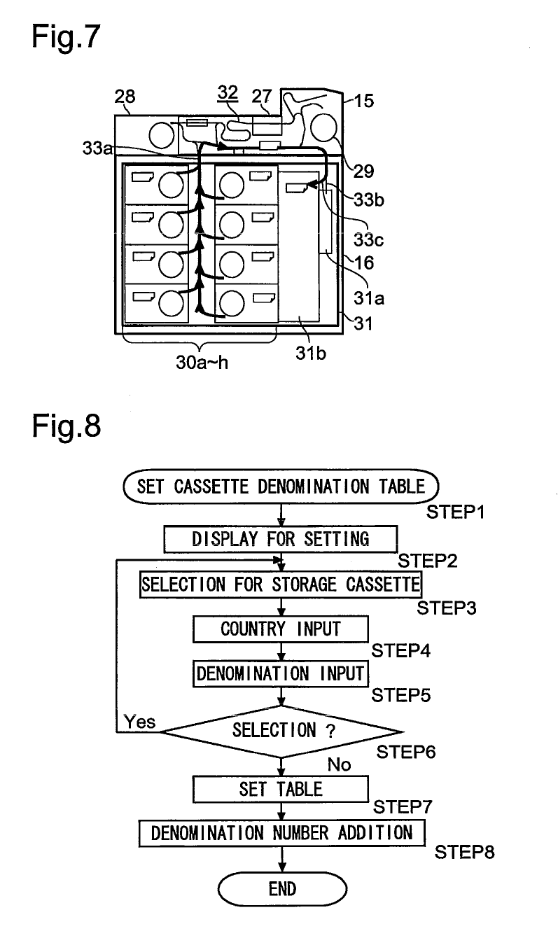

A description will now be given of the cassette denomination table 34x used in the operations for setting the order in which bills are dispensed and the order in which bills are collected, with reference to the flow chart of FIG. 8. As a result of an input for setting denominations of bills that are stored in the storage cassettes 30a to 30h being fed through the higher level terminals 12 and 13 or the operation portion 37, the upper unit control portion 34 identifies that it is requested to set the contents recorded in the cassette denomination table 34x (step 1).

When the input is fed through the operation portion 37, the display portion 20 displays a display for setting the contents recorded in the cassette denomination table 34x. When the input is fed through the higher level terminals 12 and 13, the input is received through the communication interface 36, and information of the contents that are displayed for setting the contents recorded in the cassette denomination table 34x is transmitted through the communication interface 36 to the higher level terminals 12 and 13.

When the display for setting the contents recorded in the cassette denomination table 34x is displayed on the display portion 20 or the higher level terminals 12 and 13 (step 2), the storage cassettes in which the denominations of bills that are stored are set or changed are selected by reference to the display (step 3). As an example of this display, for example, a display for indicating positions in which the storage cassettes 30a to 30h are placed within the main body 14 may be displayed. When this type of display is displayed, one of the storage cassettes 30a to 30h displayed on the operation portion 37 or the higher level terminals 12 and 13 is specified, and thus the storage cassettes in which the denominations of bills that are stored are set or changed are selected.

After a selection is made in this way to specify the storage cassettes in which the denominations of bills that are stored are set or changed, the country codes or the countries of the bills that are stored in the storage cassettes are first input through the operation portion 37 or the higher level terminals 12 and 13 (step 4). Here, it is alternatively possible to display, on the display portion 20 or the higher level terminals 12 and 13, a list of the country codes or the countries of the bills and to specify, with the displayed list, the country codes or the countries of the bills that are stored. It is also possible to directly input the country codes through the operation portion 37 or the higher level terminals 12 and 13 to specify the country codes or the countries of the bills that are stored.

After the country codes or the countries of the bills that are stored are specified in this way, the denomination codes or the denominations of the bills that are stored in the storage cassettes are input through the operation portion 37 or the higher level terminals 12 and 13 (step 5). Here, it is alternatively possible to display, on the display portion 20 or the higher level terminals 12 and 13, a list of the denomination codes or the denominations corresponding to the specified country and to specify, with the displayed list, the denomination codes or the denominations of the bills that are stored. It is also possible to directly input the country codes through the operation portion 37 or the higher level terminals 12 and 13 to specify the denomination codes or the denominations of the bills that are stored.

For example, when a 200 euro bill is stored in the storage cassette 30c, the storage cassette 30c is first specified as a storage cassette in which the denomination of a bill that is stored is set or changed. Thereafter, Europe is selected as the country of the bill that is stored, and then a 200 euro bill is selected as the denomination thereof. In this way, the country code and the denomination code of the bill that is stored in the storage cassette 30c are specified as a country code for Europe and a denomination code for a 200 euro bill.

After the country code and the denomination code of the cassette in which the denomination of the bill that is stored is set or changed are specified in this way, whether or not a selections is made to set the remaining cassettes is checked (step 6). Then, if an instruction is given to make a selection for another cassette (yes), the process proceeds to step 3, where the above-described operations are performed to set or change the denomination of the bill that is stored in such a cassette.

If, in step 6, a selection is made to set all the storage cassettes (no), the storage destination determination portion 34b sets the cassette denomination table 34x so as to indicate the storage cassettes corresponding to the specified country codes and denomination codes (step 7). Then, a denomination number is given to bills of each of different denominations specified by the country codes and denomination codes listed in the cassette denomination table 34x (step 8). Here, for example, by making the denomination numbers correspond to the storage cassettes 30a to 30h serving as the storage destinations, denomination numbers may be sequentially given to the storage cassettes 30a to 30h, starting with the storage cassette 30a. Then, the operation is completed.

2. Operations for Setting the Order in which Bills are Dispensed (the Order in which Bills are Collected)

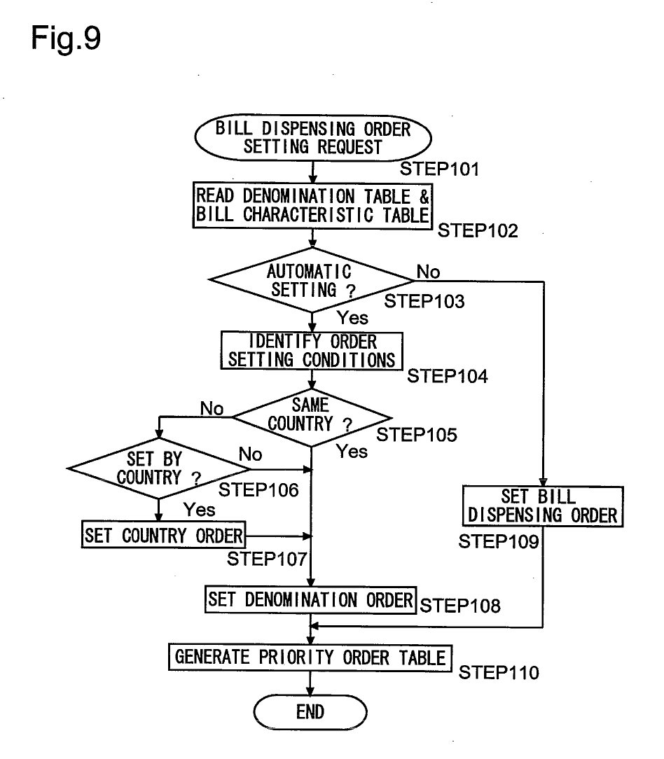

A description will now be given of the operations for setting the order in which bills are dispensed and the order in which bills are collected, using the operation for setting the order in which bills are dispensed, with reference to the flowchart of FIG. 9. First, as a result of an input for setting the order in which bills are dispensed being fed through the higher level terminals 12 and 13 or the operation portion 37, the upper unit control portion 34 identifies that it is requested to set the order in which bills are dispensed (step 101). When it is requested to set the order in which bills are dispensed, the contents stored in the cassette denomination table 34x and the bill characteristic table 34y are fed to the dispensing order determination portion 34c from the storage destination determination portion 34b (step 102).

Then, a determination is made as to whether to automatically set the order in which bills are dispensed by inputting conditions or to manually set the order by inputting and specifying the order (step 103). Here, a display for specifying which one of the above-mentioned settings is displayed on the display portion 20 and the higher level terminals 12 and 13. If the automatic setting of the order in which bills are dispensed is selected (yes in step 103), conditions (order-setting conditions) for setting the order in which bills are dispensed are determined (step 104).

As the order-setting conditions, the amount and size of a bill (such as its width, length and area) and the like are given, and selectable order-setting conditions are displayed on the display portion 20 and the higher level terminals 12 and 13. Specifically, it is possible to select from the order-setting conditions such as the decreasing order of the amount of bills, the increasing order of the amount of bills, the decreasing order of the width of bills, the increasing order of the width of bills, the decreasing order of the length of bills, the increasing order of the length of bills, the decreasing order of the area of bills and the increasing order of the area of bills.

After, in step 104, the order-setting conditions are specified through the higher level terminals 12 and 13 or the operation portion 37, a determination is made as to whether or not the country codes or countries of bills that are stored in each of the storage cassettes 30a to 30h are all the same (step 105). Here, if none of the country codes or the countries are the same (no in step 105), whether the order setting is made based on the order-setting conditions irrespective of the country or the order of the countries is input and set and then the order setting is made, on a country-by-country basis, according to the order-setting conditions is selected (step 106).

Then, if the method of inputting and setting the order of the countries is selected (yes in step 106), the order of the countries determined by the country codes of the bills stored in the storage cassettes 30a to 30h is specified through the higher level terminals 12 and 13 or the operation portion 37 (step 107). Here, on the display portion 20 and the higher level terminals 12 and 13, a list of the countries determined by the country codes of the bills stored in the storage cassettes 30a to 30h may be displayed.

The order of the countries is set as in step 107, and thus the countries become the same and the order setting is made for each of bill groups of different denominations based on the order-setting conditions (step 108). If, in step 105, it is determined that all the country codes or the countries are the same (yes), or if, in step 106, the order setting is made irrespective of the country based on the order-setting conditions (no), the process proceeds to step 108, where the order setting is made irrespective of the specified country codes or countries based on the order-setting conditions. If, as the order-setting conditions, the amount of bills is specified, the process may proceed to step 107 and then to step 108. In this case, a setting is made such that bills are dispensed, on a country-by-country basis, in the order of the amount of bills.

If, in step 103, the order is manually set by being input and specified (no), a priority order is input for each denomination number through the higher level terminals 12 and 13 or the operation portion 37, and thus the order in which bills are dispensed is set (step 109). Here, it is alternatively possible to display, on the display portion 20 and the higher level terminals 12 and 13, the denomination and country of a bill for each denomination number, and to input a priority order on a bill-type-number-by-bill-type-number basis by reference to the display.

If, in steps 108 and 109, the order in which bills are dispensed is set, the priority order table 34z indicating the denomination numbers and the storage cassettes for the priority order when bills are dispensed is generated, and is stored in the dispensing order determination portion 34c (step 110). Here, the denominations and the storage cassettes for the priority order on the set order in which bills are dispensed may be displayed on the display portion 20 and the higher level terminals 12 and 13.

An example of the above-described operation for setting the order in which bills are dispensed will be specifically shown below.

### (1) A First Operation Example

It is assumed that, in this example, as shown in the cassette denomination table 34x of FIG. 5, with respect to a plurality of types of bills whose country codes or countries are all the same and which have different denominations, the order in which the bills are dispensed is set according to the length of the bills, and that the cassette denomination table 34x shown in FIG. 5 is generated.

As shown in the cassette denomination table 34x, according to the country code or the country, euro bills of Europe are stored in the storage cassettes 30a to 30h. According to the denomination code or the denomination, 100-euro bills are stored in the storage cassette 30a, 5-euro bills are stored in the storage cassettes 30b and 30g, 200-euro bills are stored in the storage cassette 30c, 10-euro bills are stored in the storage cassette 30d, 500-euro bills are stored in the storage cassette 30e, 20-euro bills are stored in the storage cassette 30f and 50-euro bills are stored in the storage cassette 30h. A 100-euro bill is set at a first denomination; a 5-euro bill is set at a second denomination; a 200-euro bill is set at a third denomination; a 10-euro bill is set at a fourth denomination; a 500-euro bill is set at a fifth denomination; a 20-euro bill is set at a sixth denomination; and a 50-euro bill is set at a seventh denomination.

The lengths of the euro bills are stored in the bill characteristic table 34y. Specifically, a 5-euro bill, a 10-euro bill, a 20-euro bill, a 50-euro bill, a 100-euro bill, a 200-euro bill and a 500-euro bill have lengths of 119 mm, 126 mm, 132 mm, 139 mm, 145 mm, 152 mm and 159 mm, respectively.

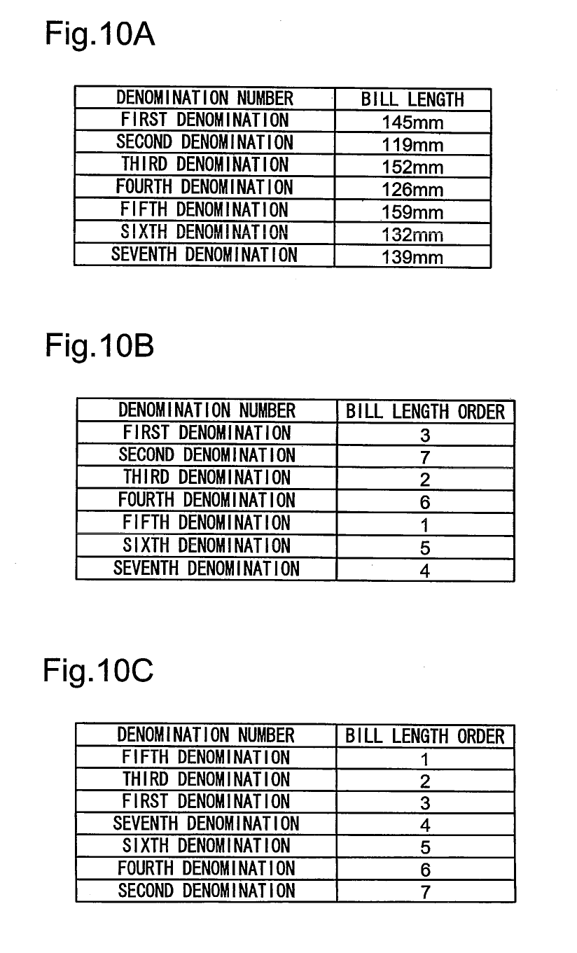

Here, if, in step 104, a higher priority is given to a bill of a longer length, in step 105, the country codes or countries of bills that are stored in the storage cassettes 10a to 10h are all the same, and thus the process proceeds to step 108. In step 108, as shown in FIG. 10A, a bill length data table is generated that indicates the length of bills of the first to the seventh denominations that are denomination numbers. Specifically, the bills of the first to the seventh denominations have lengths of 145 mm, 119 mm, 152 mm, 126 mm, 159 mm, 132 mm and 139 mm, respectively.

Then, as shown in FIG. 10B, according to the length of the bills determined by the bill length data table, a bill length order table is generated that indicates the order of the length of bills of the first to the seventh denominations, and then this bill length order table is modified as shown in FIG. 10C such that they are rearranged in the order of the length. Specifically, in the bill length order table, as shown in FIG. 10B, first, the bills of the first to the seventh denominations are ranked 3rd, 7th, 2nd, 6th, 1st, 5th and 4th, respectively, in the bill length, and then, as shown in FIG. 10C, the denominations are rearranged from the fifth denomination, to the third denomination, to the first denomination, to the seventh denomination, to the sixth denomination, to the fourth denomination and to the second denomination with respect to the order in which the bill lengths are ranked 1st, 2nd, 3rd, 4th, 5th, 6th and 7th.

As described above, the bill length order table shown in FIG. 10C, in which the denomination numbers are rearranged according to the decreasing order of the length of bills is generated, then the decreasing order of the length of bills is converted into a priority order and, in step 110, the priority order table 34z shown in FIG. 5 is generated. In the case of the bill of the second denomination being dispensed, when the storage cassette 30g is empty where no bills are stored, bills are dispensed from the storage cassette 30b.

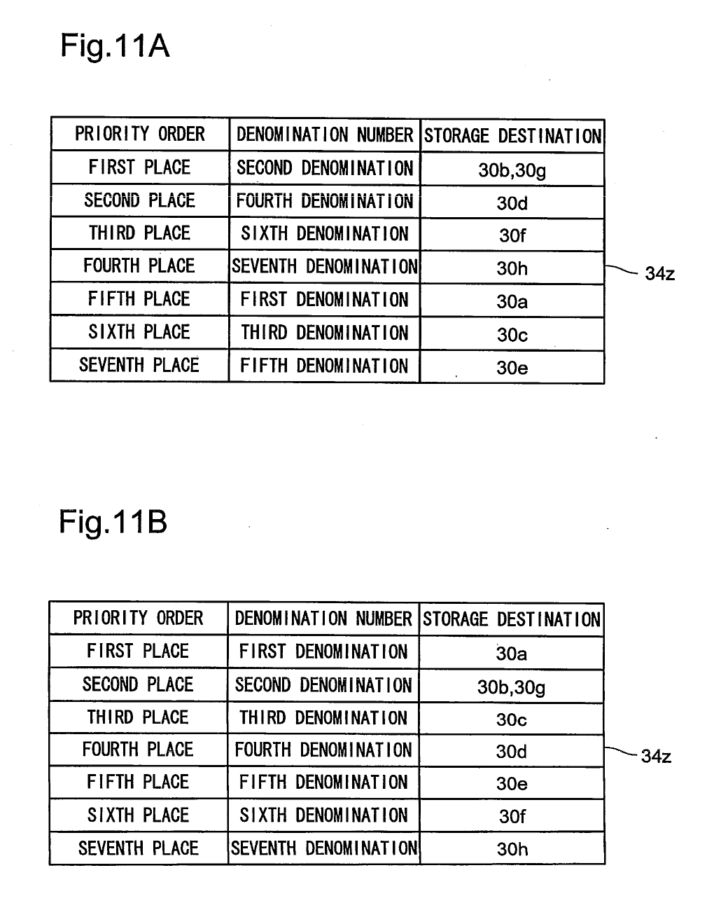

In this example, when a higher priority is given to a bill of a shorter length, in the priority order table 34z, the denomination numbers are rearranged as shown in FIG. 11A from the second denomination, to the fourth denomination, to the sixth denomination, to the seventh denomination, to the first denomination, to the third denomination and to the fifth denomination with respect to the descending priority order from the first to the seventh place. When a higher priority is given to a bill having a higher amount, as in the case where a higher priority is given to a bill of a longer length, the priority order table 34z shown in FIG. 5 is set; when a higher priority is given to a bill having a lower amount, as in the case where a higher priority is given to a bill of a shorter length, the priority order table 34z shown in FIG. 11A is set.

When no order-setting conditions are given, in the priority order table 34z, as shown in FIG. 11B, the priority order, as it is, may be used as the order of the denomination numbers

### (2) A Second Operation Example

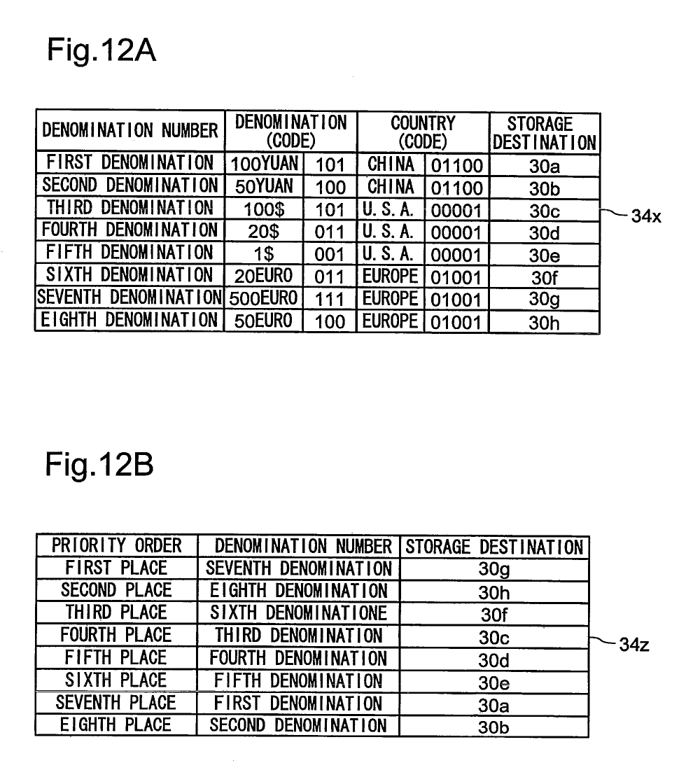

It is assumed that, in this example, as in the cassette denomination table 34x of FIG. 12A, with respect to a plurality of types of bills whose denomination codes and country codes vary, the order in which the bills are dispensed is set according to the length and country of the bills, and that the priority order table 34z shown in FIG. 12B is generated.

As shown in the cassette denomination table 34x of FIG. 12A, according to the country code, Chinese yuan bills are stored in the storage cassettes 30a and 30b, U.S. dollar bills are stored in the storage cassettes 30c to 30e and European euro bills are stored in the storage cassettes 30f to 30h.

According to the denomination code, 100-yuan bills are stored in the storage cassette 30a, 50-yuan bills are stored in the storage cassette 30b, 100-dollar bills are stored in the storage cassette 30c, 20-dollar bills are stored in the storage cassette 30d, 1-dollar bills are stored in the storage cassette 30e, 20-euro bills are stored in the storage cassette 30f, 500-euro bills are stored in the storage cassette 30g and 50-euro bills are stored in the storage cassette 30h.

A 100-yuan bill is set at the first denomination; a 50-yuan bill is set at the second denomination; a 100-dollar bill is set at the third denomination; a 20-dollar bill is set at the fourth denomination; a 1-dollar bill is set at the fifth denomination; a 20-euro bill is set at the sixth denomination; a 500-euro bill is set at the seventh denomination; and a 50-euro bill is set at the eighth denomination. Although not shown, according to the bill characteristic table 34y, a 100-yuan bill is longer than a 50-yuan bill, and all dollar bills have the same length.

Here, when a higher priority is given to a bill of a longer length in step 104, in step 105, none of the country codes of the bills stored in the storage cassettes 10a to 10h is the same, and thus the process proceeds to step 106. When an order setting is made irrespective of the country code based on the length of a bill, the process proceeds to step 108, where the order setting is made as in the first example and then the priority order table 34z is generated in step 110.

In this example, the order is also determined according to the country, and thus the process proceeds from step 106 to step 107, where a priority order is set according to the country. Here, it is assumed that an input is fed such that the countries are prioritized from Europe, to the U.S.A. and to China. Then, the process proceeds to step 108, where, first, the lengths of European euro bills having the first priority on the country are compared, then the lengths of U.S. dollar bills having the second priority on the country are compared and, finally, the lengths of Chinese yuan bills having the third priority on the country are compared.

When these comparisons are performed, the order of the length of the euro bills is a 500-euro bill, to a 50-euro bill and to a 20-euro bill, all the dollar bills have the same length and the order of the length of the yuan bills is a 100-yuan bill to a 50-yuan bill. Thus, in the priority order table 34z, as shown in FIG. 12B, the denomination numbers are arranged from the seventh denomination, to the eighth denomination, to the sixth denomination, to the third denomination, to the fourth denomination, to the fifth denomination, to the first denomination and to the second denomination with respect to the descending priority order from the first to the eighth place, and storage cassettes corresponding to the denomination numbers are stored. Here, since the dollar bills have the same length, the order is set according to the order of the denomination numbers. When bills have the same length, the order may be set according to the amount of bills.

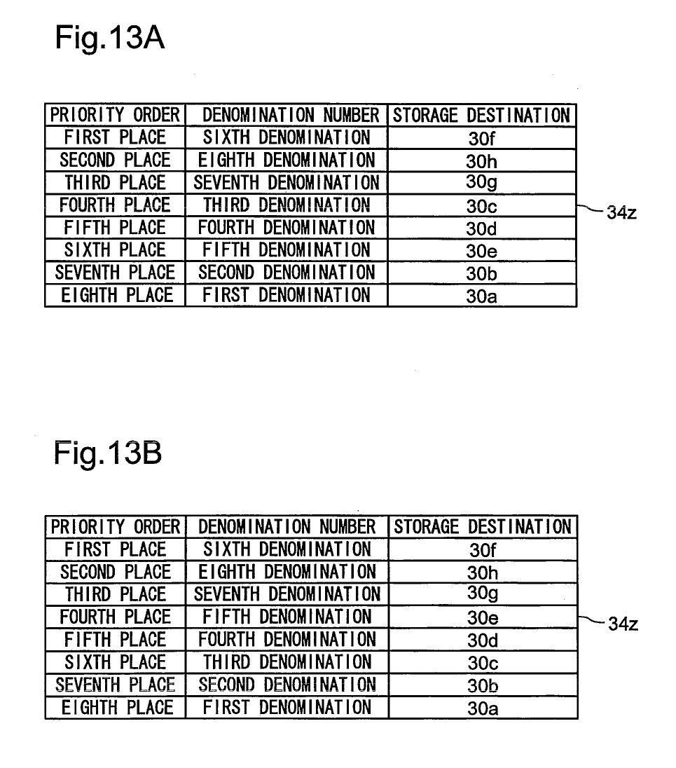

In this example, when a higher priority is given to a bill of a shorter length, in the priority order table 34z, as shown in FIG. 13A, the denomination numbers are arranged from the sixth denomination, to the eighth denomination, to the seventh denomination, to the third denomination, to the fourth denomination, to the fifth denomination, to the second denomination and to the first denomination with respect to the descending priority order from the first to the eighth place. When a higher priority is given to a bill having a higher amount, as in the case where a higher priority is given to a bill of a longer length, the priority order table 34z shown in FIG. 12B is set. When a higher priority is given to a bill having a lower amount, as in the priority order table 34z shown in FIG. 13B, the denomination numbers are arranged from the sixth denomination, to the eighth denomination, to the seventh denomination, to the fifth denomination, to the fourth denomination, to the third denomination, to the second denomination and to the first denomination with respect to the descending priority order from the first to the eighth place.

When, as in this example, a priority order is also set according to the country, bills may be dispensed on a country-by-country basis when bills are dispensed. Specifically, when all the bills of one country are dispensed from the dispensing portion 29 to the outlet 17, after they are removed from the outlet 17, the bills of the country having the following priority are dispensed. Here, as a result of an input for indicating that bills have been removed from the outlet 17 being fed through the higher level terminals 12 and 13 or the operation portion 37, the bills of the country having the following priority start being dispensed.

Thus, when bills are dispensed based on the priority order table 34z shown in FIG. 12B, euro bills are first fed from the storage cassette 30g, to the storage cassette 30h and to the storage cassette 30f, and are then dispensed through the dispensing portion 29 to the outlet 17. Then, when an input for indicating that the dispensed euro bills have been removed from the outlet 17 is fed, dollar bills are fed from the storage cassette 30c, to the storage cassette 30d and to the storage cassette 30e, and are then dispensed through the dispensing portion 29 to the outlet 17. Finally, when an input for indicating that the dispensed dollar bills have been removed from the outlet 17 is fed, yuan bills are fed from the storage cassette 30a to the storage cassette 30b, and are then dispensed through the dispensing portion 29 to the outlet 17.

As described above, according to the flow chart of FIG. 9, the priority order table 34z is set and the order in which bills are dispensed is set. The operation for setting the order in which bills are dispensed is described above, and the operation for setting the order in which bills are collected is achieved by performing the same operation as that shown in the flow chart of FIG. 9. Specifically, operations in steps 101 to 109 are performed to set the order in which bills are collected, and, in step 110, in the dispensing order determination portion 34c, the set order in which bills are collected is stored in the collection order table 34w, and thus the setting of the order in which bills are collected is completed.

Although, in this embodiment, the setting of the denominations of the bills that are stored in the storage cassettes 30a to 30h and the setting of the order in which bills are dispensed or the order in which bills are collected are performed by the bill depositing and dispensing machine 11, using the upper unit control portion 34, they may be performed through the higher level terminals 12 and 13 to set the cassette denomination table 34x, the priority order table 34z and the collection order table 34w. Here, the cassette denomination table 34x, the priority order table 34z and the collection order table 34w that are set through the higher level terminals 12 and 13 are received through the communication interface 36, and are then stored in the storage destination determination portion 34b and the dispensing order determination portion 34c of the upper unit control portion 34.

Although, in the display portion 20, the display contents indicating operation steps are controlled by the upper unit control portion 34, the display contents may be able to be stored in an erasable memory and updated by a network or a storage medium. Every time the operation steps are switched, the display contents corresponding to the operation steps may be received from the higher level terminals 12 and 13 through the communication interface 36 and be displayed by the upper unit control portion 34 on the display portion 20.

Although, in the above-described embodiment, the invention is described by way of example, using the bill depositing and dispensing machine incorporating a winding-type (tape-type) bill storage portion, the bill depositing and dispensing machine incorporating a stack-type bill storage portion that stacks and stores the bills may be used instead.

### INDUSTRIAL APPLICABILITY

Although, in the above-described embodiment, the invention is described by way of example, using the bill depositing and dispensing machine that is used by a teller in a financial institution, the invention is applicable to a bill dispensing machine for only dispensing bills, a change dispensing machine for dispensing bills as change, ATMs and the like.

1. A bill handling device having a plurality of bill storage portions that can store bills by type and that can feed the bills one by one and a bill dispensing portion in which bills fed from the bill storage portions are stacked the bill handling device comprising:
a transporting portion that transports bills;
a memory that stores both storage destination information including information related to types of the bills stored in the bill storage portions and priority order information related to a priority order for types of the bills fed from the bill storage portions;
a setting/changing portion that sets or changes the priority order information stored in the memory; and
a control portion for controlling an operation of feeding, when the bill is dispensed, the bill from the bill storage portions based on the storage destination information and the priority order information stored in the memory and of transporting the bill to the bill dispensing portion.

2. The bill handling device of claim 1,
wherein the memory stores characteristic information on characteristics of the bills according to the types of the bills, and the setting/changing portion sets or changes the priority order information based on the characteristic information stored in the memory.

3. The bill handling device of claim 2,
wherein the characteristic information includes a size of the bills as a characteristic of the bills.

4. The bill handling device of claim 3,
wherein the setting/changing portion sets or changes the priority order information according to an order of the size of the bills that is determined by the characteristic information stored in the memory.

5. The bill handling device of claim 2,
wherein the characteristic information includes an amount of the bills as a characteristic of the bills.

6. The bill handling device of claim 5,
wherein the setting/changing portion sets or changes the priority order information according to an order of the amount of the bills that is determined by the characteristic information stored in the memory.

7. The bill handling device of claim 1,
wherein, when the bills include bills of a plurality of countries, the setting/changing portion sets or changes the priority order information of the bills for each country.

8. The bill handling device of claim 1, further comprising:
a bill depositing portion into which the bills are put; and
a bill identification portion identifying types of the bills deposited through the bill depositing portion,
wherein the types of the bills deposited through the bill depositing portion are identified by the bill identification portion and then the control portion controls an operation of determining, based on the storage destination information stored in the memory, the bill storage portions serving as storage destinations corresponding to the types of the bills identified by the bill identification portion and of transporting said bills to said bill storage portions.

9. The bill handling device of claim 8,
wherein the bill identification portion has an identification template referenced when the bill identification portion identifies the types of the bills, and the memory stores, according to the types of the bills, characteristic information, acquired from the identification template, on characteristics of the bills, and the setting/changing portion sets or changes the priority order information based on the characteristic information stored in the memory.

10. The bill handling device of claim 1, further comprising:
a bill collection portion that collects all the bills stored in the bill storage portions,
wherein, when the bills are collected, based on the storage destination information and the priority order information stored in the memory, the control portion controls an operation of changing, according to the types of the bills, an order in which the bill storage portions are operated to feed the bills and of transporting the bills to the bill collection portion.

11. The bill handling device of claim 1,
wherein the bill handling device is connected to a higher level terminal through which an instruction for an operation is given, and the control portion identifies the instruction from the higher level terminal to perform the operation corresponding to the instruction.

12. The bill handling device of claim 11,
wherein a display for an operation is displayed on a screen of the higher level terminal and image information to be displayed on the screen is transmitted to the higher level terminal.

13. The bill handling device of claim 2,
wherein the bill handling device is connected to a higher level terminal through which an instruction for an operation is given, and the control portion identifies the instruction from the higher level terminal to perform the operation corresponding to the instruction.

14. The bill handling device of claim 3,
wherein the bill handling device is connected to a higher level terminal through which an instruction for an operation is given, and the control portion identifies the instruction from the higher level terminal to perform the operation corresponding to the instruction.

15. The bill handling device of claim 4,
wherein the bill handling device is connected to a higher level terminal through which an instruction for an operation is given, and the control portion identifies the instruction from the higher level terminal to perform the operation corresponding to the instruction.

16. The bill handling device of claim 5,
wherein the bill handling device is connected to a higher level terminal through which an instruction for an operation is given, and the control portion identifies the instruction from the higher level terminal to perform the operation corresponding to the instruction.

17. The bill handling device of claim 6,
wherein the bill handling device is connected to a higher level terminal through which an instruction for an operation is given, and the control portion identifies the instruction from the higher level terminal to perform the operation corresponding to the instruction.

18. The bill handling device of claim 7,
wherein the bill handling device is connected to a higher level terminal through which an instruction for an operation is given, and the control portion identifies the instruction from the higher level terminal to perform the operation corresponding to the instruction.

19. The bill handling device of claim 8,
wherein the bill handling device is connected to a higher level terminal through which an instruction for an operation is given, and the control portion identifies the instruction from the higher level terminal to perform the operation corresponding to the instruction.

20. The bill handling device of claim 9,
wherein the bill handling device is connected to a higher level terminal through which an instruction for an operation is given, and the control portion identifies the instruction from the higher level terminal to perform the operation corresponding to the instruction.

21. The bill handling device of claim 10,
wherein the bill handling device is connected to a higher level terminal through which an instruction for an operation is given, and the control portion identifies the instruction from the higher level terminal to perform the operation corresponding to the instruction.
